(19) United States
(12) Patent Application Publication
(10) Pub. No.: US 2012/0008195 A1
(43) Pub. Date: Jan. 12, 2012

(54) MICROSCOPE SYSTEM

(75) Inventors: Artur Hoegele, Oberkochen (DE); Christoph Hauger, Aalen (DE); Fenny Nauli, Aalen (DE)

(73) Assignee: Carl Zeiss Meditec AG, Jena (DE)

(21) Appl. No.: 13/177,005

(22) Filed: Jul. 6, 2011

(30) Foreign Application Priority Data
Jul. 6, 2010 (DE) 10 2010 026 171.8

(51) Int. Cl. G02B 21/02

(52) U.S. Cl. 359/380

(57) ABSTRACT

Microscope system for acquiring a plurality of images, comprising: a zoom system which is configured to continuously vary a magnification of the microscope system over a magnification range of the microscope system, wherein the zoom system comprises two movable zoom components, which are arranged movably along a common optical axis of the microscope system; an aperture stop, which is configured such that a plurality of different observation beam paths of the microscope system are selectable, which traverse the zoom system; wherein the aperture stop, as seen along the optical axis, is arranged between the two movable zoom components; and wherein for all values of the magnification within the magnification range, the aperture stop is located within an aperture stop range which is measured along the optical axis and which surrounds a pupil position of the microscope system.

### CROSS-REFERENCES TO RELATED APPLICATIONS

The present application claims priority of German Patent Application No. 10 2010 026 171.8, filed on Jul. 6, 2010, and entitled “Microscope System”, the contents of which is hereby incorporated by reference in its entirety.

### FIELD

The invention relates to microscope systems, in particular digital microscope systems. More specifically, the invention relates to digital microscope systems, which comprise an aperture which is adaptable to imaging conditions and/or which allow to acquire spatial information from a group of individual images of an object, such as a stereoscopic image or a stereoscopic video sequence.

### BACKGROUND

There are microscopes known in the art, which provide the observer with a stereoscopic view of an object. Typically, the object is simultaneously or sequentially imaged by two observation beam paths of the stereo microscope, which are different from each other. The bundles of rays of the two observation beam paths form a stereo angle in the object plane.

Two types of stereo microscopes are commonly known. One of these types is the telescope type stereo microscope, in which the two observation beam paths do not traverse a common optical component. The second one is the Greenough-type stereo microscope which has two objective lenses, which may be mounted within a common frame.

Stereo microscopes are widely used in the field of medicine and are particularly useful for eye surgeries. They also proved to be an important inspection tool in the fields of biology and microelectronics.

In some of these applications, there is only limited space available for installing the microscope. By way of example, in an operating theatre, numerous examination instruments are arranged close to the operating field, restricting the space available for positioning the microscope. Furthermore, additional space is necessary for the hands of the surgeon and for various instruments to allow the surgeon to carry out the surgical procedures.

Accordingly, it is an object to provide a versatile microscope system, which is compact in size.

### SUMMARY OF THE INVENTION

According to embodiments, there is provided a microscope system for acquiring a plurality of images, comprising: a zoom system which is configured to continuously vary a magnification of the microscope system over a magnification range of the microscope system, wherein the zoom system comprises two movable zoom components, which are arranged movably along a common optical axis of the microscope system; an aperture stop, which is configured such that a plurality of different observation beam paths of the microscope system are selectable, which traverse the zoom system; wherein the aperture stop, as seen along the optical axis, is arranged between the two movable zoom components; and wherein for all values of the magnification within the magnification range, the aperture stop is located within an aperture stop range which is measured along the optical axis and which surrounds a pupil position of the microscope system.

Accordingly, since the aperture stop is located within the zoom system, microscope system is obtained, which is compact in size. In particular, for a given f-number, a compact microscope system is obtained. The microscope may be compact in size with respect to lens diameters and the overall length of the microscope system. Moreover, artefacts such as a brightness gradient appearing in the images (e.g. vignetting or unsymmetrical image cropping) are reduced.

Moreover, by selecting observation beam paths with the aperture stop, stereoscopic images and/or video sequences are obtainable without providing separate optical elements for a left and a right observation beam path. Additionally or alternatively, by selecting observation beam paths with the aperture stop, it is possible to select a form and a size of the aperture depending on imaging conditions and magnification settings of the zoom system. Thereby, the microscope system is versatile.

Furthermore, the microscope system is highly versatile since it is adaptable to meet the needs of a specific application. Since the observation beam path is selectable by the aperture stop, the microscope system may be adaptable with respect to the position of the microscope system relative to the object, the orientation of the microscope system relative to the object, the position of the observer relative to the object, and/or the orientation of the observer relative to the object. Furthermore, a brightness and/or depth of focus of an observation beam path may be adjustable. Also, the selecting of the observation beam path by the aperture stop allows to generate stereoscopic images by selecting a right and a left stereo channel.

The microscope system may comprise more than two movable zoom components. At least one or each of the movable zoom components may consist of a lens, a cemented element or a mirror. At least one or each of the movable zoom components may comprise a group of lenses, cemented elements and/or mirrors.

The movable zoom components of the zoom system may be designed such that they are movable along the optical axis. The zoom system may be configured such that a movement of at least one or all of the movable zoom components along the optical axis results in a variation of the magnification of the microscope system. The zoom system may consist of two movable zoom components and one or more stationary zoom components. In other words, a number of the movable zoom components of the microscope system may be two.

The zoom system may comprise one or more actuators, which are attached to the movable zoom components, and which are connected in signal communication with a controller of the microscope system. The controller may be configured such that by transmitting signals from the controller to the actuators, the magnification of the microscope system is adjustable.

By moving the at least two movable zoom components, a magnification of the microscope system may be continuously adjustable over a magnification range. The zoom system may have a zoom ratio of for example at least 4:1 (i.e. 4×), at least 5:1 (i.e. 5×), or at least 6:1 (i.e. 6×). The zoom ratio may be less than 10:1 (i.e. 10×).

The microscope system may be configured as a digital microscope system. The microscope system may comprise a image capture system comprising an image sensor which is arranged in an image plane of the microscope system and which is configured to acquire images generated in the image plane. The image sensor may be a CCD image sensor. Additionally or alternatively, the image capture device may comprise image sensors, such as a 1CCD sensor, a 1CMOS sensor, and/or a 3CCD image sensor.

The microscope system may be configured to acquire a group of images of an object under inspection. For each of the images of the group of images, a respective observation beam path may be selected by the aperture stop. The observation beam paths which are selected for acquiring the images of the group of images may be different from each other. The microscope system may be configured such that a stereoscopic image is generated depending on the group of images. The stereoscopic image may comprise a left and a right half image. The group of images may be acquired sequentially. The term “sequentially” may mean that after a first image of the group of images has been acquired, a second image of the group of images is acquired. Between the first and the second image, further images may be acquired. It is also conceivable, that a plurality of images of the group of individual images are acquired with a same observation beam path. For example, images, which are acquired with the same observation beam path, may be averaged in order to reduce imaging artefacts.

The aperture stop may be connected in signal communication to a controller, wherein the controller is configured to transmit control signals to the aperture stop for selecting the observation beam path.

The aperture stop may comprise an opaque area and a light transmissive area, which are both oriented perpendicular to the optical axis and are located in the beam path such that a portion of the light rays, which is incident on the light transmissive area, passes the aperture stop. Thereby, the light transmissive area may form an aperture. A form of the light transmissive area may be configurable. By setting the form of the light transmissive area of the aperture stop, the observation beam path may be selectable. The microscope system may comprise a controller, which is configured to transmit control signals from a controller to the aperture stop to select the observation beam path, for example by setting the form of the light transmissive area. It is also conceivable that one observation beam path is selected by letting all light rays pass which are incident on the aperture stop.

The aperture stop may be arranged stationary. Alternatively, aperture stop may be arranged movably along the optical axis. The microscope system may comprise actuators, which are attached to the aperture stop and which are connected in signal communication with the controller of the microscope system. The movement of the movable aperture stop may be controllable by signals transmitted from the controller to the actuators.

The term “pupil” may be defined herein as the location, at which centroid rays, which emanate from different locations in the object plane, intersect. Depending on the design and aberrations of the optical elements of the microscope system, the pupil may comprise a plurality of different points. Hence, the locations at which the centroid rays intersect may represent not a single point, but an extended region.

The term “centroid ray” may be defined herein as the energy-weighted average of all rays, which emanate from a point in the object plane and which traverse the microscope system from the object plane to the image plane. In the image plane, the images are detected by the image sensor or observed with an eyepiece by an observer. The rays, which emanate from the same point in the object plane may be weighted with the same energy. Hence, to each point in the object plane, which is imaged onto a corresponding point in the image plane, a centroid ray may be assigned. The centroid ray traverses the microscope system from a point in the object plane to the corresponding point in the image plane.

When determining the centroid rays which determine the position of the pupil, the aperture stop is assumed not to block out any light rays. In other words, when determining the centroid rays, the energy-weighted average of those light rays are calculated, which traverse the microscope system disregarding the aperture stop.

The aperture stop may be arranged at the position or close to the position of the pupil on the optical axis. In this case, vignetting or unsymmetrical image cropping does not occur.

The aperture stop may be located not exactly at the position of the pupil on the optical axis but may slightly deviate from this position. This may be acceptable as long as this does not cause a significant effect on the images. The effect may be not significant, when it is not perceived by the observer as disturbing and/or it does not have a detrimental effect on the result of image processing routines applied to the images. Hence, the aperture stop may be arranged within an aperture stop range, which surrounds the location or region of the pupil.

In other words, the aperture stop range may be defined as a region along the optical axis, wherein the region surrounds the position of the pupil on the optical axis and wherein an aperture stop being arranged within the aperture stop range still yields acceptable images.

The aperture stop range may be smaller than half of an overall length of the microscope system measured along the optical axis. In particular, the aperture stop range may be smaller than one fifth, or smaller than one tenth, or smaller than one hundredth, or smaller than one thousandth of the overall length of the microscope system.

Furthermore, the microscope system may be configured such that the pupil is located at a constant or substantially constant position for all magnifications. In this case, the aperture stop may be arranged at or substantially at the position of the pupil. In this case, the aperture stop range may have a length of zero or substantially of zero.

According to an embodiment, the microscope system is configured as a digital microscope system for acquiring spatial information of an object from at least a group of sequentially acquired images of the object, wherein the aperture stop is further configured such that for each image of the group of images, one of the different observation beam paths is selectable, such that the observation beam paths of at least two images of the group of images are different from each other. The aperture stop may be configured to also operate as a shutter.

According to an embodiment, the microscope system is configured such that a pupil range measured along the optical axis, has a length, which is smaller than a maximum distance of positions of lens vertices of the two movable zoom components.

The maximum distance of the positions of the vertices of lenses may be measured along the optical axis. The vertices of lenses of the movable zoom components may have different positions on the optical axis depending on the magnification of the zoom system. The maximum distance is determined depending on the positions of all magnifications. Hence, for determining the maximum distance, positions of the lens vertices of different magnifications for the two movable zoom components may be considered. For example, the maximum distance may be calculated from a vertex position of the first movable zoom at a first magnification and from a position of the second movable zoom component at a second magnification, which is different from the first magnification. In other words, the maximum distance is calculated depending on a maximum distance of a lens vertex of the first movable zoom component from the aperture stop and a maximum distance of a lens vertex of the second movable zoom component from the aperture stop. In case the movable zoom component has more than one lens vertex, the maximum distance is measured from the lens vertex among all lens vertices, which yields the greatest distance.

The maximum distance of the positions of the vertices of lenses of the movable zoom components may for example be shorter than 80 mm, or shorter than 50 mm, or shorter than 40 mm. The maximum distance may be within a range of 30 to 80 mm, within a range of 30 to 50 mm or within a range of 30 to 40 mm.

The position of the pupil on the optical axis may vary along the optical axis, caused in particular by a variation of the magnification of the microscope system. The pupil position may also vary depending on a variation of a working distance of the microscope system.

The pupil range of the microscope system may be defined as the range along the optical axis, which represents the sum of pupil positions of all magnifications of the microscope system. The pupil range may additionally be the sum of pupil positions of all working distances of the microscope system. In other words, adjusting the magnification and/or working distance of the microscope system in the whole adjustable range leads to a variation of the location or region of the pupil which defines the pupil range. A short pupil range may therefore mean that the pupil position only slightly varies depending on an adjustment of the magnification and/or working distance.

A short pupil range allows to arrange the aperture stop such that for all magnifications, the aperture stop is arranged close to the position of the pupil. Thereby, artefacts in the images caused by the aperture stop not being located exactly at the pupil position are reduced.

According to an embodiment, the pupil range may has a length measured along the optical axis, which is smaller than one half, or smaller than one fifth, or smaller than one tenth, or smaller than one hundredth of the maximum distance of the positions of the lens vertices of the two movable zoom components.

According to an embodiment, the microscope system further comprises: an object side focusing system, which comprises a movable focusing component, wherein the microscope system is configured such that by moving the movable focusing component along the optical axis, a working distance of the microscope system is adjustable.

The working distance may be defined as a distance along the optical axis between the object plane and a refractive surface of the microscope system, which is located closest to the object plane among all refractive surfaces of the microscope system. By moving the movable focusing component, the working distance of the microscope system may be adjustable at least over a range from 50 mm to 150 mm or at least over a range from 100 mm to 300 mm or at least over a range from 200 mm to 500 mm.

The object side focusing system may be arranged on the optical axis between the object plane and the zoom system. The movable focusing component may consist of a lens, a cemented element and/or a mirror. Alternatively, the movable focusing component may comprise a group of lenses, a group of cemented elements and/or a group of mirrors.

The object side focusing system may comprise one or more actuators, which are attached to the movable focusing component and which are connected in signal communication with the controller of the microscope system. The controller may be configured such that by transmitting signals of the controller to the actuators, the working distance of the microscope system is adjustable.

Accordingly, by providing a microscope system having an object side focusing system, the working distance is adjustable. In particular, this allows the physician to position the microscope system relative to the patient without being constrained by a fixed working distance of the microscope system. Thereby, the microscope system is easier to handle and provides an enhanced versatility of positioning and adjustment.

According to an embodiment, the microscope system is configured such that for all working distances, the aperture stop is located within the aperture stop range surrounding the position of the pupil.

According to an embodiment, at least one of the two movable zoom components or each of the two movable zoom components has a negative refracting power.

The negative refracting power may be a negative spherical refractive power.

According to an embodiment, the two movable zoom components are symmetrical or substantially symmetrical to each other.

The term symmetrical may mean that the refracting surfaces of the movable zoom components are symmetrical with respect to a plane, which is arranged perpendicular to the optical axis and which is located between the two movable zoom components.

According to an embodiment, the zoom system further comprises a first group of two stationary zoom components, which are arranged on the optical axis between the two movable zoom components.

The aperture stop may be arranged between the stationary zoom components of the first group.

According to an embodiment, at least one or both of the stationary zoom components of the first group may have a positive refracting power. According to a further embodiment, the stationary zoom components of the first group may be symmetrical or substantially symmetrical. According to a further embodiment, the aperture stop is arranged on the optical axis between the zoom components of the first group. The stationary zoom components may be configured to be non-movable along the optical axis. The term symmetrical may mean that the refracting surfaces of the stationary zoom components of the first group are symmetrical with respect to a plane, which is arranged perpendicular to the optical axis and which is located between the two stationary zoom components.

The two stationary zoom components of the first group may comprise a first refractive surface, wherein a light ray emanating from the object plane first traverses this first refractive surface after having passed the aperture stop. Additionally or alternatively, the two stationary zoom components of the first group may comprise a second refractive surface, wherein the second refractive surface is the last refractive surface which is traversed by a light ray emanating from the object plane before being incident on or before traversing the aperture stop.

In other words, no further refractive surfaces are arranged on the optical axis between the refractive surfaces of the stationary zoom components of the first group, which enclose the aperture stop.

In an alternative embodiment, the two movable zoom components comprise a first refractive surface which is first traversed by a light ray coming from the object plane after having passed the aperture stop. Furthermore, the two movable zoom components comprise a last refractive surface, which is last traversed by a light ray coming from the object surface before entering the aperture stop.

In other words, according to this embodiment, there are no further refractive surfaces arranged on the optical axis between the refractive surfaces of the two movable zoom components, which enclose the aperture stop.

According to a further embodiment, the zoom system further comprises a second group of two stationary zoom components arranged on the optical axis, wherein the movable zoom components are arranged between the two stationary zoom components of the second group.

It is conceivable that between the movable zoom components and the zoom components of the second group, there are arranged further components of the zoom system.

According to a further embodiment, one or each of the stationary zoom components of the second group has a positive refracting power.

The positive refracting power may be a spherical positive refracting power.

According to a further embodiment, the stationary zoom components of the second group are symmetrical or substantially symmetrical to each other.

According to an embodiment, the aperture stop is configured such that the observation beam paths are selectable by a variable aperture of the aperture stop.

In particular, the aperture stop may be configured to adapt on or a combination of a form, a size and a position of the aperture. Thereby, the aperture stop comprises a variable aperture. The variable aperture of the aperture stop may be arranged perpendicular or substantially perpendicular to the optical axis.

Accordingly, since the aperture stop has a variable aperture, it is possible to adapt the observation beam path of the microscope system to the object, to the magnification, to the position of the microscope system relative to the object and/or to the position of the observer relative to the object. Furthermore, it allows to vary the observation beam path between two images such that a left and a right half image of a stereoscopic image may be acquired.

According to an embodiment, the aperture stop may be configurable to shut out all light rays. The aperture stop may comprise a shutter element. Thereby, the aperture stop may be configured to also operate as a shutter.

According to a further embodiment, the aperture stop comprises one or more area elements, wherein each of the one or more area elements is configured to be switchable between an open and a closed state.

Each of the area elements may be switchable between an open and a closed state. The area element may be a shutter element. One or more of the area elements may be switchable independently from the remaining area elements. In other words, the area elements of the aperture stop may be switchable such that a first portion of the area elements is in the open state and a second portion of the area elements is in the closed state. The first and the second portion may consist of one or more area elements. The aperture stop may be configured such that at least two or all of the area elements are simultaneously switchable between an open and a closed state.

The area elements may be arranged in a common plane of the aperture stop, which is oriented perpendicular to the optical axis. The area elements may be overlapping or non-overlapping. The aperture stop may be configured such that at least two different apertures of the aperture stop are selectable. Thereby, the aperture stop may provide a variable aperture. By each of the at least two different apertures, an observation beam path may be selectable. The selected observation beam paths may be different from each other. By selecting one or more of the area elements to be in an open state, the aperture and thereby the observation beam path is selectable. The remaining area elements may be in a closed state.

According to an embodiment, the aperture stop is configured such that an aperture of the aperture stop is rotatable about the optical axis.

The aperture stop may comprise a rotatably mounted component, such that by rotating the rotatably mounted component, the aperture of the aperture stop is varied. Thereby, the aperture stop comprises a variable aperture. For example, the rotatably mounted component may be a rotatable disk having one or more apertures.

By way of example, the aperture stop may be configured such that it comprises a component which is rotatably mounted about the optical axis. Thereby, a position of the aperture may be rotatable about the optical axis. Additionally or alternatively, it is conceivable that through an opening and closing of area elements of the aperture stop, the variable aperture of the aperture stop may be rotatable.

By way of example, the variable aperture may be rotatable by +/−45 degrees, or +/−90 degrees, or +/−135 degrees and/or 180 degrees. Additionally or alternatively, the variable aperture may be continuously rotatable about the optical axis.

According to a further embodiment, the aperture stop comprises one or a combination of a mechanical shutter element, a polymer shutter element and an LCD-matrix.

By way of example, a mechanical shutter element may comprise one or a plurality of flaps and/or blades. The flap or blade may be pivotably mounted. The flap and/or blade may be configured to be switchable between a closed and an open state. At least a portion of the surface of the flap or blade may correspond to an area element of the aperture stop. The aperture stop may comprise a plurality of flaps and/or blades wherein each or a group of flaps and/or blades are switchable between an open and a closed state.

A polymer shutter element may be an EC polymer shutter element. The polymer shutter element may be configured such that each of a plurality of portions of the polymer shutter element are individually controllable to scatter incident light. By applying an external electrical field, crystals within the polymer shutter element are aligned such that the polymer shutter element is opaque or substantially opaque for incident rays of light. In the closed state, the polymer shutter element may be in a coloured state, i.e. being opaque for a predetermined wavelength range.

Upon switching off the electrical field, the polymer shutter element is switched to be light transmissive or substantially light transmissive. The polymer shutter element may have a switching time of less than one millisecond. Furthermore, the polymer shutter element may comprise a pair of transparent plane-parallel plates and an active layer, which is arranged between the plane-parallel plates. The active layer may comprise free liquid molecules, which are obtained by a photopolymerization in the presence of conventional liquid crystals. The polymer shutter element may further comprise electrodes which are configured to generate the electrical field and which may be configured to be light transmissive.

The embodiments described herein are not limited to such a polymer shutter element. It is conceivable, that the microscope system comprises other designs of the polymer shutter.

A polymer shutter element allows to acquire individual images with a comparatively short exposure time. Furthermore, the polymer shutter element is comparatively compact in size in the direction along the optical axis. Thereby, the polymer shutter element only slightly limits the space required for a movement of the movable zoom components.

According to a further embodiment, the plurality of different observation beam paths comprise a left and right stereo channel.

The left stereo channel may be defined as an observation beam path, wherein a left half image of a stereoscopic image may be acquired when the left stereo channel is selected. Accordingly, a right half image of a stereoscopic image may be acquired when the right stereo channel is selected. Also the right stereo channel may be one of the observation beam paths of the microscope system. A first image may be acquired with the left stereo channel and a second image may be acquired with the right stereo channel. A left half image of a stereoscopic image may be generated depending on the first image and a right half image of a stereoscopic image may be generated depending on the second image.

The left and the right stereo channel need not be symmetrical. For example, the size of the aperture for providing the left stereo channel may be different from the size of the aperture for providing the right stereo channel.

The left and right half image of a stereoscopic image may represent two perspectives of the same object. The perspectives may be such that the observer is provided with a three dimensional impression of the object when the left half image is observed with the left eye and the right half image is observed with the right eye.

The microscope system may further comprise an image processing unit, which is configured to process the individual images of the left and/or right stereo channel for obtaining the stereoscopic half images.

By way of example, the left stereo channel may be selected by an opening of a first area element or a first group of area elements of the aperture stop. Accordingly, the right stereo channel may be selected by an opening of a second area element or a second group of area elements. The area elements of the first group of area elements and the area elements of the second group of area elements may be different from each other. The first group and the second group may comprise common area elements or may comprise no common area elements.

It is also conceivable, that by rotating the rotatable component about the optical axis, the microscope system is switched from the left stereo channel to the right stereo channel or from the right stereo channel to the left stereo channel. The rotatably mounted component may comprise an aperture. By way of example, the aperture may be rotated by 180 degrees about the optical axis to switch between the left stereo channel and the right stereo channel.

Furthermore, by rotating the variable aperture of the aperture stop for switching between the left and the right stereo channel, an orientation of an axis of the observation beam path of the left stereo channel in an object plane and an orientation of an axis of the observation beam path of the right stereo channel in the object plane may be adjustable.

Thereby, it is possible to adapt the orientation of the axes of the observation beam paths to a position of the microscope system relative to the object and/or to a position of the observer relative to the object. Furthermore, it is thereby possible to generate stereoscopic half images for a plurality of observers, which have different positions and/or orientations with respect to the object plane.

The rotation of the variable aperture may be rotated synchronously with the images of the stereo channels. Thereby, it is possible to generate stereoscopic half images depending on the acquired images, wherein the stereoscopic half images represent a left and a right stereoscopic perspective and yield a three-dimensional impression when viewed by a human viewer.

According to a further embodiment, each of the plurality of observation beam paths has an f-number, which is less than 16, or less than 12, or less than 10, or less than 8, or less than 6.

The f-number may be defined as the object side focal length divided by a diameter of the entrance pupil of the observation beam path. The object side focal length may be the focal length of the object side focusing system

A smaller f-number corresponds to a high lens speed of the microscope system. A high lens speed allows to generate images with a short exposure time. Thereby, image sharpness of the images may be increased. Furthermore, a small f-number allows to generate video sequences having a high spatial and a high time resolution. The f-numbers may be f-numbers of a right and a left stereo channel.

According to a further embodiment, an overall length of the microscope system is less than 200 mm, or less than 150 mm, or less than 120 mm or less than 100 mm.

The overall length of the microscope system may be defined as the length along the optical axis between a refractive surface of the microscope system, which is located closest to the object plane, and the image plane. The refractive surface, which is located closest to the object plane is a refractive surface among all refractive surfaces of the microscope system which is first traversed by light rays, which emanate from the object plane. The overall length may be greater then 80 mm or greater then 100 mm.

According to a further embodiment, a zoom ratio of the microscope system is at least 4×, or at least 5× or at least 6×.

By providing a microscope system having a high zoom ratio, the microscope system is versatile. In particular, the magnification of the microscope system may be adapted to the specific surgical operation conducted by the surgeon. For example, it is possible for the surgeon to select between a first operation mode providing a large field of view and a second operation mode providing a high magnification, the zoom ratio may be less than 15×, or less than 20×, or less than 30×.

According to a further embodiment, the microscope system further comprises an image side focusing system, wherein a focal length of the image side focusing system is larger than a distance along the optical axis between a refractive surface of the image side focusing system, which is located closest to the zoom system, and the image plane.

The image side focusing system may be arranged on the optical axis between the zoom system and the image plane.

By way of example, the focal length of the image side focusing system may 49 mm or more; or 50 mm or more. The focal length of the image side focusing system may be less than 70 mm or less than 80 mm. The distance along the optical axis between the refractive surface of the image side focusing system, which is arranged closest to the zoom system and the image plane may be for example be 50 mm or less or 45 mm or less or 40.11 mm or less.

Accordingly, a microscope system is provided which has a short overall length, since the distance between the zoom system and the image plane is comparatively short as a result of the design of the image side focusing system.

According to a further embodiment, the aperture stop is switchable between an open and a closed state. According to a further embodiment, an opening time of the aperture stop is less than 500 ms, or less than 200 ms, or less than 100 ms.

By providing a microscope system having an aperture stop with a short exposure time, sharp images having a high spatial resolution are obtainable. Furthermore, short exposure times allow acquiring video sequences having a high time resolution. Thereby, it is possible for the surgeon to observe movements of his hands in real time. The opening time may be at least 50 ms or at least 100 ms.

According to an embodiment, the aperture stop comprises an aperture, in particular a variable aperture and a shutter, wherein the aperture and the shutter are both arranged within the aperture stop range of the microscope system.

The aperture may be arranged immediately in front of or immediately behind the shutter. In other words, between the shutter and the aperture, there are no further refractive surfaces or apertures. By way of example, the aperture stop may comprise a first and a second aperture, wherein the first aperture is configured to define a left stereo channel and the second aperture is configured to define the right stereo channel. The shutter may be configured to let light pass either through the first aperture or through the second aperture.

According to a further embodiment, the zoom system is at least one of afocal, substantially afocal, symmetrical and substantially symmetrical.

An afocal zoom system allows to vary the magnification of the zoom system without having to adapt other components, such as the object side focusing system and/or the image side focusing system of the microscope system. Thereby, by providing an afocal zoom system, a microscope system is obtained which has a comparatively simple design and which is compact in size.

A symmetrical zoom system may be defined as a zoom system, wherein the refractive surfaces of the zoom system, which are located at a first side with respect to a plane of symmetry of the zoom system, are symmetrically identical or substantially symmetrically identical to the refractive surfaces of the zoom system, which are located on the other side with respect to the plane of symmetry. In other words, the refractive surfaces of the zoom system are in mirror symmetry or substantially in mirror symmetry with respect to a plane of symmetry, which is oriented perpendicular to the optical axis of the microscope system. The locations of the refractive surfaces on the optical axis do not need to be in mirror symmetry with respect to the plane of symmetry. In particular, the locations of the movable zoom components do not need to be symmetrical with respect to the symmetry plane. Rather, the positions of the movable zoom components may depend on the magnification being set. At the point of intersection or substantially at the point of intersection between the plane of symmetry and the optical axis, the pupil may be located.

Accordingly by providing a symmetrical zoom system a microscope system may be obtained, which is cost efficient to manufacture since a plurality of refractive surfaces, such as lenses and/or cemented elements may be manufactured in the same manufacturing step. Furthermore, by providing a symmetrical zoom system, the location of the pupil is located in the middle or close to the middle of the zoom system. Thereby, a compact zoom system is obtained having a short overall length and comparatively small lens diameters, wherein the zoom system still has a sufficiently high zoom factor.

### BRIEF DESCRIPTION OF THE DRAWINGS

The forgoing as well as other advantageous features of the invention will be more apparent from the following detailed description of exemplary embodiments of the invention with reference to the accompanying drawings. It is noted that not all possible embodiments of the present invention necessarily exhibit each and every, or any, of the advantages identified herein.

FIG. 1a schematically illustrates a microscope system according to a first exemplary embodiment;

FIG. 1b schematically illustrates the beam path of two ray bundles including their centroid rays in the microscope system according to the first exemplary embodiment;

FIG. 1c schematically shows a microscope system according to a second exemplary embodiment;

FIG. 2a shows a selected left stereo channel in the microscope system according to the first exemplary embodiment;

FIG. 2b shows a selected right stereo channel in the microscope system according to the first exemplary embodiment;

FIG. 3 schematically shows the microscope system according to the first exemplary embodiment at different magnification settings;

FIGS. 4a to 4c schematically illustrate exemplary embodiments of the aperture stop; and

FIG. 5 schematically shows the aperture stop, a controller for controlling the aperture stop, and an image acquiring system according to an exemplary embodiment.

### DETAILED DESCRIPTION OF EXEMPLARY EMBODIMENTS

In the exemplary embodiments described below, components that are alike in function and structure are designated as far as possible by alike reference numerals. Therefore, to understand the features of the individual components of a specific embodiment, the descriptions of other embodiments and of the summary of the invention should be referred to.

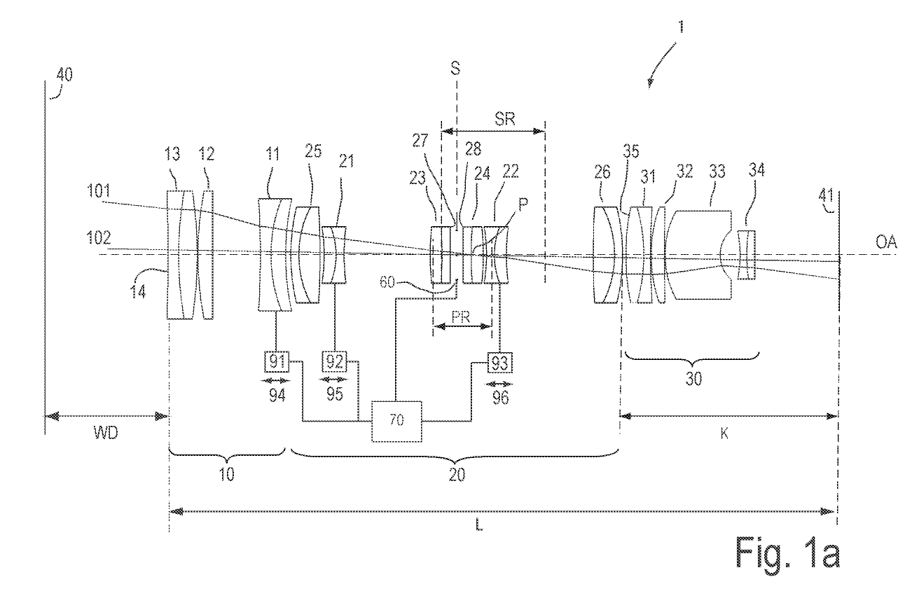

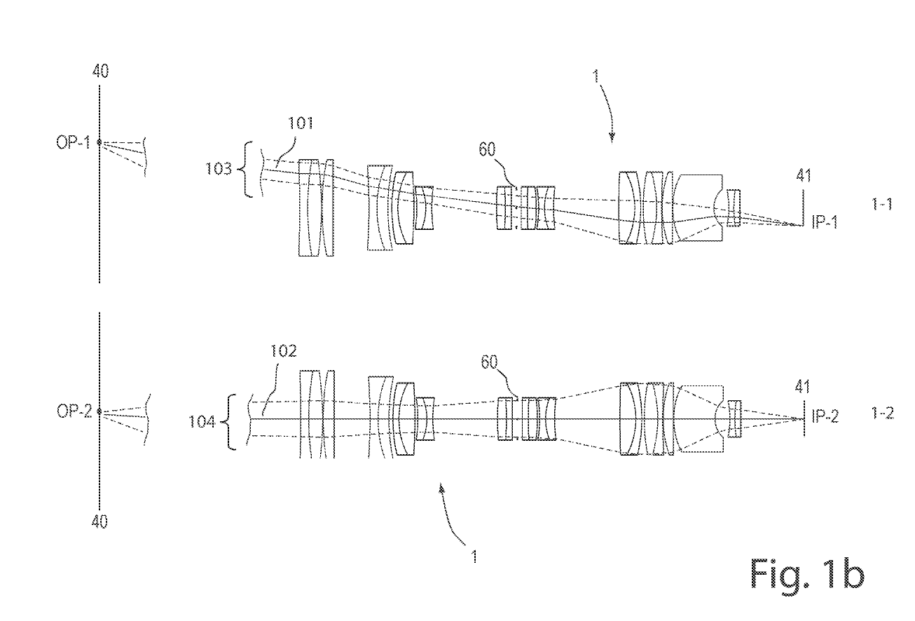

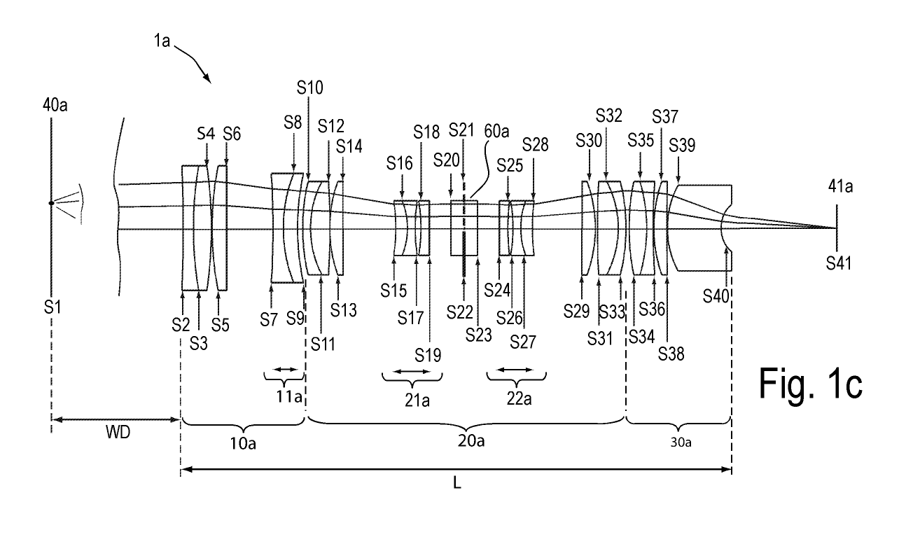

FIG. 1a schematically shows a microscope system 1 according to a first exemplary embodiment. The microscope system 1 comprises an object side focusing optical system 10, a zoom system 20 and an image side focusing optical system 30. Light rays, which emanate from a point on the object plane 40 are focused on a point in the image plane 41. The object side focusing optical system 10 is arranged on the optical axis OA between the zoom system 20 and the object plane 40. The image side focusing system is arranged on the optical axis between the zoom system 20 and the image plane 41.

For simplicity of illustration, the distance between the object plane 40 and the object side focusing optical system 10 is shown out of scale.

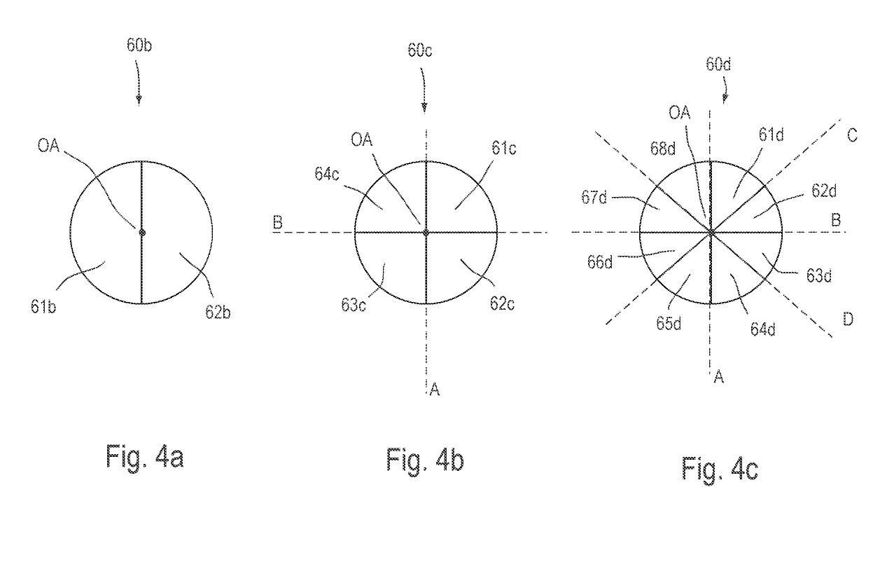

The microscope system 1 further comprises an image capture system (discussed below with reference to FIG. 4). The image capture system is configured to capture images generated in the image plane 41. The image capture system may comprise an image sensor, which may be arranged in the image plane 41. By way of example, the image sensor may comprise a comprises a 1CCD, a 1CMOS and/or a 3CCD-image sensor. A 3CCD-image sensor comprises three CCD-sensors, which are arranged at a trichroic beam splitter prism assembly.

The zoom system 20 comprises two movable zoom components 21 and 22, which are configured to be movable along the optical axis OA, as indicated by double arrows 95 and 96 in FIG. 1. Actuators 92, 93 are attached at each of the movable zoom components 21, 22. The actuators are connected in signal communication with a controller 70 of the microscope system 1. The controller 70 is designed such that the magnification of the microscope system 1 is adjustable by control signals transmitted from the controller 70 to the actuators 92 and 93.

Furthermore, the zoom system 20 comprises four stationary components 23, 24, 25, 26. Each of the stationary zoom components may have a positive refracting power. A magnification of the microscope system 1 is adjustable by moving the movable zoom components 21, 22 along the optical axis OA. The zoom system 20 of the microscope system 1 is a 6× zoom. Each of the movable zoom components has a negative refracting power.

A first stationary component 24 comprises a first refractive surface 28. A light ray, which emanates from the object plane 40 and which has passed the aperture stop 60, first traverses the refractive surface 28. Furthermore, a second stationary component 23 comprises a last refractive surface 27. The light ray, which emanates from the object plane 40 and which has passed the last refractive surface 27, first traverses the aperture stop 60.

The refractive surfaces of the movable and stationary components of the zoom system 20 are symmetrical or substantially symmetrical with respect to a plane of symmetry S of the zoom system 20. The term “configured to be symmetrical” as used herein may mean that the refractive surfaces of the zoom components on a first side with respect to the plane of symmetry S are configured to be identical or substantially identical to the zoom components on the other side of the plane of symmetry S. In particular, symmetrically corresponding refractive surfaces of the zoom components on both sides of the plane of symmetry S may be configured to be identical or substantially identical. The positions of the components of the zoom system may not necessarily be symmetrical with respect to the plane of symmetry S.

The object side focusing system 10 comprises a movable focusing component 11, which is configured to be movable along the optical axis OA, as indicated by double arrow 94. The movable focusing component 11 is a cemented element. The object side focusing system 10 further comprises a stationary cemented element 13 and a stationary lens 12. An actuator 91 is attached to the movable focusing component 11. The controller 70 is connected in signal communication with the actuator 91. The controller 70 is configured such that the working distance WD of the microscope system 1 is adjustable by transmitting control signals from the controller 70 to the actuator 91.

By moving the movable focusing component 11 along the optical axis OA, a working distance WD of the microscope system 1 is adjustable. The working distance WD may be defined as a distance between the object plane 40 and a refractive surface 14. The refractive surface 14 is the refractive surface among all refractive surfaces of the microscope system 1, which is arranged closest to the object plane. The working distance WD of the microscope system 1 is adjustable over a range from 100 mm to 300 mm.

The range of magnifications within which the magnification of the microscope system 1 is adjustable by the zoom system 20 may depend on the set working distance WD. For example, at a working distance of 200 mm, imaging scale object-image may be within a range of between 0.126 and 0.76. Furthermore for an object distance of 500 mm an imaging scale object-image may be within a range of between 0.045 and 0.27.

In FIG. 1a two centroid rays 101 and 102 are shown, which traverse the microscope system 1. The centroid rays 101, 102 intersect at the location of the pupil P of the microscope system 1. Upon varying the magnification of the microscope system 1 by moving the movable zoom components 21, 22, the location of the pupil P may vary. Furthermore, the location of the pupil P may also vary caused by moving the movable focus component 11 along the optical axis OA, i.e. when the working distance WD is varied.

The pupil range PR denotes the range of a displacement of the pupil along the optical axis OA.

An aperture stop 60 of the microscope system 1 is arranged between the stationary zoom components 23, 24. The aperture stop 60 is arranged stationary in the microscope system 1. Furthermore, the aperture stop 60 is arranged such that for all adjustable magnifications and for all adjustable working distances WD of the microscope system 1, the aperture stop 60 is located within an aperture stop range SR, which surrounds the location of the pupil P. The aperture stop 60 is connected in a signal communication with a controller 70. The controller 70 is configured to transmit signals to the aperture stop 60 for controlling the selecting of the observation beam path.

Since the aperture stop 60 is arranged in the aperture stop range SR, which surrounds the pupil P, artefacts, which are generated by the aperture stop 60 are not perceived by the observer as disturbing and/or do not have a detrimental effect on the images when the images are further processed.

The aperture stop 60 is configured to select for each image from a group of images, which are acquired, an observation beam path of the microscope system 1. By way of example, the aperture stop 60 is configured to select for two images a left stereo channel and a right stereo channel. The images of the left and the right stereo channel are captured by the image capture system. A left half image is generated depending on the image which has been acquired with the left stereo channel. A right half image is generated depending on the image which has been acquired with the right stereo channel. The left half image and the right half image form a stereoscopic image. The microscope system 1 may comprise a head-mounted display (not illustrated). The head-mounted display may be configured such that the observer observes the left half image with his left eye and the right half image with his right eye.

An image side focusing system 30 is arranged on the optical axis OA between the zoom system 20 and the image plane 41. The image side focusing system 30 comprises two stationary cemented elements 31, 34 and two stationary lenses 32, 33. The image side focusing system 30 further comprises a refractive surface 35, which is located closest to the zoom system 20 from among all refractive surfaces of the image side focusing system. A distance K along the optical axis OA between the refractive surface 35, which is located closest to the zoom system 20 and the image plane 41 is shorter than a focal length of the image side focusing system 30. Hence, a microscope system 1 is provided having a short overall length L, since there is only a comparatively small space required between the zoom system 20 and the image plane 41.

FIG. 1b shows a beam paths 1-1 and 1-2 of a first and a second bundle of light rays 103, 104 in the microscope system 1, which is illustrated in FIG. 1a. The first bundle of light rays 103 emanates from a first point OP-1 in the object plane 40. For simplicity of illustration, the distance between the object plane 40 and the microscope system 1 is shown out of scale. The second bundle of light rays 104 emanates from a point OP-2 in the object plane 40. The aperture stop 60 is configured to let all incident light rays pass. The energy-weighted average of the first bundle of light rays 103 is represented by the first centroid ray 101. The energy-weighted average of the second bundle of light rays 104 is represented by the second centroid ray 102. The first bundle of light rays 103 is imaged onto a first image point IP-1 in the image plane 41. The second bundle of light rays 104 is imaged onto a second image point IP-2 in the image plane 41. In determining the centroid rays, it is assumed that the aperture stop 60 does not block out any light rays. In other words, the centroid rays are determined without considering the aperture stop 60.

FIG. 1c schematically shows a second exemplary embodiment of the microscope system 1a. The microscope system 1a is configured to image points in the object plane 41 onto points in the image plane 41a. The microscope system 1a comprises an object side focusing system 10a, a zoom system 20a and an image side focusing system 30a. The zoom system 20a comprises two movable zoom components 21a, 22a. The magnification of the microscope system 1a is adjustable by moving the movable zoom components 21a. The object side focusing system 10a comprises a movable focusing component 11a. The object side focusing system 10a is configured such that by moving the movable focusing component 11a, a working distance WD is adjustable.

The movable zoom component 21a comprises a last refractive surface S19, wherein a light ray, which emanates from the object plane 40a and which has traversed the last refractive surface S19, first traverses the aperture stop 60a. Furthermore, the movable zoom component 22a comprises a first refractive surface S24, wherein a light ray, which emanates from the object plane 40a and which has traversed the aperture stop 60a first traverses the first refractive surface S24.

The movable zoom components 21a, 22a comprise refractive surfaces S19, S24. For each side with respect to the aperture stop 60a, the refractive surface S19 and the refractive surface S24, respectively, is the refractive surface among all refractive surfaces of the microscope system 1, which is located closest to the aperture stop 60a. In other words, no refractive surfaces are located between the refractive surfaces S19 and S24 and the aperture stop 60a.

Table 1 lists geometrical and optical parameters of surfaces S2 to S40 of the microscope system 1a. S1 denotes a surface in the object plane 40. S41 denotes a surface in the image plane 41. The surfaces S2 to S40 are traversed by the light rays of the observation beam paths which emanate from the object plane 40a in the order as listed in table 1. The parameter R denotes a radius of curvature of the respective surface in millimetres. The parameter D denotes a distance between the surfaces along the optical axis in millimetres. The parameter DM denotes the useful free radius or half the free diameter of the surface. Furthermore, the glass material from which the lenses are made is indicated with an index. The wavelength dependency of the refractive indices of each of these glass materials are listed in table 3 below.

TABLE 1

| surface No. | R (mm) | D (mm) | glass No. | | DM (mm) |
|---|---|---|---|---|---|
| S 1 | 0.000000 | 200.000000 | object plane 40a | | |
| S 2 | 1022.284181 | 1.200000 | 1 | ! | 11.000 |
| S 3 | 44.074621 | 3.200000 | 2 | ! | 11.000 |
| S 4 | −45.393581 | 0.010000 | | ! | 11.000 |
| S 5 | 34.992983 | 2.000000 | 2 | ! | 11.000 |
| S 6 | 253.836746 | 7.000000 | | ! | 11.000 |
| S 7 | −87.455992 | 1.200000 | 3 | ! | 9.000 |
| S 8 | 14.946796 | 2.300000 | 1 | ! | 9.000 |
| S 9 | 29.066270 | 2.000000 | | ! | 9.000 |
| S 10 | −258.201245 | 1.200000 | 4 | ! | 8.000 |
| S 11 | 21.755729 | 2.500000 | 2 | ! | 8.000 |
| S 12 | −64.132246 | 0.010000 | | ! | 8.000 |
| S 13 | 28.052941 | 1.700000 | 2 | ! | 8.000 |
| S 14 | −395.721151 | 12.004000 | | ! | 8.000 |
| S 15 | −80.565091 | 1.000000 | 1 | ! | 5.500 |
| S 16 | −23.955658 | 1.000000 | 2 | ! | 5.500 |
| S 17 | 28.507382 | 1.500000 | | ! | 5.500 |
| S 18 | −37.977364 | 1.000000 | 2 | ! | 5.500 |
| S 19 | 0.000000 | 5.086000 | | ! | 5.500 |
| S 20 | 0.000000 | 3.000000 | | ! | 6.000 |
| S 21 | 0.000000 | 0.000000 | | ! | 6.000 |

aperture 21; aperture radius = 3.000 mm; decentering of aperture = 3.000

| | | | | | |
|---|---|---|---|---|---|
| S 22 | 0.000000 | 3.000000 | 5 | ! | 6.000 |
| S 23 | 0.000000 | 5.000000 | | ! | 6.000 |
| S 24 | 0.000000 | 1.000000 | 2 | ! | 5.500 |
| S 25 | 37.977364 | 1.500000 | | ! | 5.500 |
| S 26 | −28.507382 | 1.200000 | 2 | ! | 5.500 |
| S 27 | 23.955658 | 1.000000 | 1 | ! | 5.500 |
| S 28 | 80.565091 | 11.890000 | | ! | 5.500 |
| S 29 | 395.721151 | 1.700000 | 2 | ! | 8.000 |
| S 30 | −28.052941 | 0.010000 | | ! | 8.000 |
| S 31 | 64.132246 | 2.500000 | 2 | ! | 8.000 |
| S 32 | −21.755729 | 1.200000 | 4 | ! | 8.000 |
| S 33 | 258.201245 | 0.010000 | | ! | 8.000 |
| S 34 | 34.218706 | 3.200000 | 2 | ! | 8.000 |
| S 35 | −19.646248 | 1.200000 | 4 | ! | 8.000 |
| S 36 | 104.373256 | 0.010000 | | ! | 8.000 |
| S 37 | 15.828489 | 2.200000 | 2 | ! | 8.000 |
| S 38 | 59.168159 | 0.010000 | | ! | 8.000 |
| S 39 | 14.233811 | 8.097772 | 6 | ! | 7.500 |
| S 40 | 6.417033 | 25.469052 | | ! | 4.500 |

| | | |
|---|---|---|
| S 41 | 0.000000 | image plane 41a |

The surface S2 is the refractive surface among all refractive surfaces of the microscope system 1a which is located closest to the object plane 40a. Between the object plane 40a and the surface S2 there is a working distance WD of 200 mm. The object side focusing system 10a comprises surfaces S2 to S9. The movable focusing component 11a comprises the surfaces S7 to S9. The zoom system 20a comprises the surfaces S10 to S19 and S24 to S33. A first movable zoom component comprises the surfaces S15 to S19. A second movable zoom component comprises the surfaces S24 to S28. The zoom system 20a is symmetrical. The image side focusing system 30a comprises the surfaces S34 to S40. The surface S41 denotes the position of the image plane 41a.

The surface S34 is a refractive surface among all refractive surfaces of the image side focusing system 30a, which is located closest to the zoom system 20. Between the surface S34 and the image plane 41a there is a distance of 40.11 mm along the optical axis. The focal length of the image side of focusing system 30a is 50 mm. Hence, the focal length of the image side of focusing system 30a is greater than the distance between the refractive surface S34 and the image plane 41a. Thereby, a microscope system 1a is provided having a small overall length L. The overall length L of the microscope system 1a is the distance between the refractive surface S2 and the image plane 41a. The refractive surface S2 is the refractive surface among all refractive surfaces of the microscope system 1, which is located closest to the object plane 40a.

An shutter of the microscope system 1a and an aperture, both forming an aperture stop 60a, comprise the surfaces S20 to S23.

Table 2 lists the distance along the optical axis between lens surfaces S14, S19, S23 and S28 in millimetres for three magnification settings Z1, Z2 and Z3.

TABLE 2

| | |
|---|---|
| distance: S14 Z1 | .486000 |
| distance: S14 Z2 | 12.004000 |
| distance: S14 Z3 | 16.704000 |
| distance: S19 Z1 | 16.604000 |
| distance: S19 Z2 | 5.086000 |
| distance: S19 Z3 | .386000 |
| distance: S23 Z1 | .299000 |
| distance: S23 Z2 | 5.000000 |
| distance: S23 Z3 | 16.515000 |
| distance: S28 Z1 | 16.591000 |
| distance: S28 Z2 | 11.890000 |
| distance: S28 Z3 | .375000 |

Table 3 lists the refractive indices of the glass materials, which are listed in table 1 with, wherein the wavelength of the light is given in nm.

TABLE 3

| wavelength [nm]: | 546.0740 | 643.8469 | 479.9914 | 435.8343 |
|---|---|---|---|---|
| glass No. 1 | 1.812640 | 1.797512 | 1.829723 | 1.847243 |
| glass No. 2 | 1.620325 | 1.615509 | 1.625344 | 1.630091 |
| glass No. 3 | 1.670000 | 1.663241 | 1.677192 | 1.684142 |
| glass No. 4 | 1.727937 | 1.718703 | 1.738029 | 1.748013 |
| glass No. 5 | 1.518722 | 1.514719 | 1.522829 | 1.526685 |
| glass No. 6 | 1.819915 | 1.810912 | 1.829498 | 1.838745 |

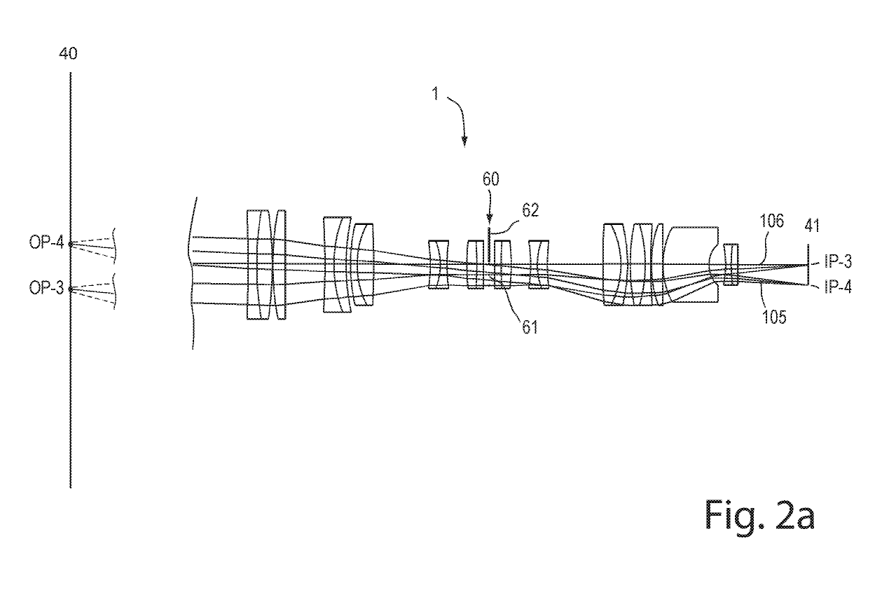

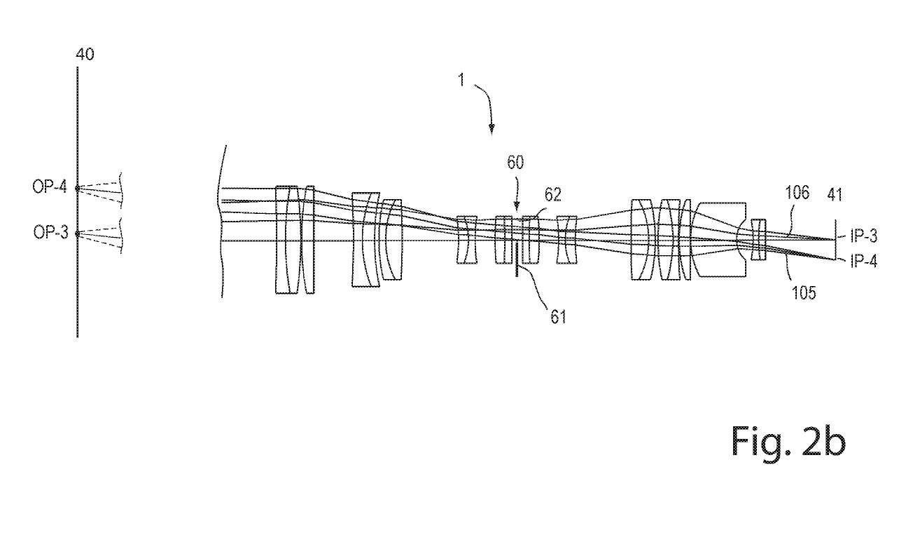

FIG. 2a schematically shows the microscope system 1, wherein the aperture stop 60 selects an observation beam path for a first individual image of a group of individual images. The observation beam path represents a first stereo channel which is for example a left stereo channel. In other words, a left half image is generated depending on the image which is acquired with the stereo channel which is illustrated in FIG. 2a.

The aperture stop 60 comprises a first area element 61, which is switchable between an open and a closed state. Furthermore, the aperture stop 60 comprises a second area element 62 which is also configured to be switchable between an open and a closed state. For selecting the first stereo channel, the second area element 62 is switched to a closed state and the first area element 61 is switched to an open state. Moreover, the first area element 61 and the second area element 62 may be switchable to a closed state. Thereby, the aperture stop 60 is switchable between an open and a closed state. In other words, the aperture stop may also act as a shutter.

Bundles of light rays 105, 106 emanate from object points OP-3 and OP-4 within the object plane 40. The light rays of the bundles 105, 106 traverse the microscope system 1 and are imaged onto points IP-3 and IP-4 in the image plane 41.

FIG. 2b schematically illustrates the microscope system 1, wherein the aperture stop 60 selects an observation beam path for a second individual image of the group of individual images. The observation beam path represents a second stereo channel, such as for example a right stereo channel. Light rays emanate from object points OP-3 and OP-4 in the object plane 40. The bundles of light rays traverse the microscope system 1 and are imaged onto image points IP-3 and IP-4. For selecting the second stereo channel, the first area element 61 is switched to a closed state and the second area element 62 is switched to an open state.

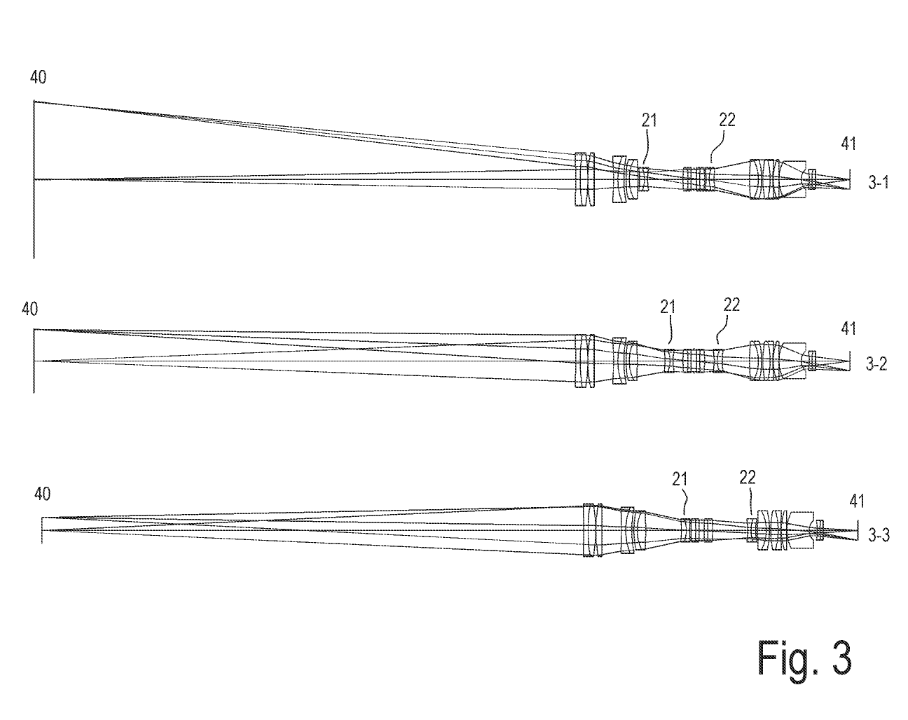

FIG. 3 illustrates bundles of light rays of three beam paths 3-1, 3-2 and 3-3 of the microscope system 1, wherein the positions of the movable zoom components 21, 22 are different in each of the three beam paths. The beam paths 3-1, 3-2 and 3-3 represent different magnifications. By moving the movable zoom components along the optical axis OA, the magnification of the microscope system 1 is continuously adaptable between the magnifications represented by beam paths 3-1, 3-2 and 3-3.

The microscope system 1 may be configured such that the zoom system has a zoom ratio of at least 4×, or at least 5× or of at least 6×.

FIGS. 4a to 4c illustrate exemplary embodiments 60b, 60c and 60d of the aperture stop. The aperture stops 60b, 60c and 60d are illustrated such that the optical axis OA is located perpendicular to the paper plane of FIGS. 4a to 4c.

The aperture stop 60b comprises a first area element 61b and a second area element 62b. Each of the area elements 61b and 62b has the form of a semicircle.

A first stereo channel, for example a left stereo channel is selectable by switching the first area element 61b to an open state and the second area element 62b to a closed state. A second stereo channel, for example a right stereo channel is selectable by switching the second area element 62b to an open state and the first area element 61b to a closed state.

Alternatively or in an alternative operation mode, a right stereo channel may be selectable by switching the first area element 61b to an open state and by switching the second area element 62b to an closed state and left stereo channel may be selectable by switching the first area element 61b to a closed state and the second area element 62b to a closed state. Thereby, the apertures of the stereo channels are rotated by 180 degrees.

The aperture stop 60c represents a different exemplary embodiment. The aperture stop 60c comprises four area elements 61c, 62c, 63c and 64c. The area elements form a plurality of circular sectors of equal size. The aperture stop 60c is configured such that the area elements 61c, 62c, 63c and 64c are individually switchable between an open state and a closed state. Thereby, four observation beam paths are selectable. Additionally or alternatively, the aperture stop 60c may be configured such that more than one area element are simultaneously switchable between the open state and the closed state. By way of example, area elements 61c and 62c may be simultaneously switchable to an open state, whereby an observation beam path of a first stereo channel relative to the axis A is selectable. Accordingly, an observation beam path of a second stereo channel relative to the axis A is selectable by switching area elements 63c and 64c to an open state. The first and the second stereo channels may represent a left and a right stereo channel for acquiring a stereoscopic image.

Furthermore, by simultaneously switching the area elements 61c and 64c to an open state, an observation beam path of a third stereo channel relative to the axis B is selectable. Accordingly, by simultaneously switching the area elements 62c and 63c to an open state, an observation beam path of a fourth stereo channel relative to the axis B is selectable. The third and the fourth stereo channels may represent a left and a right stereo channel for acquiring a stereoscopic image.

Hence, the aperture stop 60c allows to rotate the apertures of a left and a right stereo channel by +90 degrees, −90 degrees or 180 degrees.

Furthermore, the microscope system 1 may be configured such that synchronously with a rotation of the apertures of the stereo channels, a rotation of the images of the individual images is performed. The rotation of the images may be performed by an image processing unit. Thereby, even when the apertures of the stereo channels have been rotated, the observer is still provided with a left and a right half image, which allow him to get a three-dimensional impression from the object.

FIG. 4c shows a further exemplary embodiment of an aperture stop 60d. The aperture stop 60d comprises eight area elements 61d to 68d. The area elements 61d to 68d form circular sectors of equal size. Therefore, each of the area elements 61d to 68d has the form of one-eighth of a circle (i.e. of an octant). By way of example the area elements 61d to 68d are individually switchable between an open and a closed state. Thereby, eight different observation beam paths may be selectable.

Furthermore, aperture stop 60c allows to rotate the apertures of a left and a right stereo channel by +/−45 degrees, +/−90 degrees, +/−135 degrees or 180 degrees.

The aperture stops 60b, 60c and 60d, which are illustrated in FIGS. 4a to 4c may be configured such that by simultaneously switching all area elements of the respective aperture stop to an open state, an observation beam path is selectable which allows to acquire a monoscopic image. Thereby, the microscope system 1 may be configured such that monoscopic images of an object are acquirable, which have a higher resolution than the stereoscopic half images.

For example in addition to acquiring two images by selecting a left and a right stereo channel, a further image may be acquired having a large aperture.

By numerically combining the monoscopic image with the stereoscopic half images, it is possible to increase the resolution of the stereoscopic half images.

Furthermore, it is conceivable, that the microscope system 1 is operable in different operation modes. The operation modes may comprise a monoscopic imaging acquisition mode and a stereoscopic imaging mode. The individual images acquired with the monoscopic imaging mode may have a higher resolution than images acquired with the stereoscopic imaging mode. The observation beam path of the monoscopic imaging mode may be selected by switching to an aperture having a diameter which is larger than diameters of the apertures in the stereoscopic imaging mode.

In the stereoscopic imaging mode, a left and a right stereoscopic half image are acquired with the left and the right stereo channel. Furthermore, the operation modes may comprise a mixed imaging mode, in which monoscopic images are combined with stereoscopic half images by applying a numerical image processing routine. Thereby, stereoscopic half images may be obtained having a higher resolution and/or reduced artefacts.

Thereby, a versatile microscope system 1 is obtained, since, depending on the specific requirements of a surgical operation, a suitable operation mode of the microscope system 1 is selectable. The monoscopic imaging mode allows to acquire images having a high spatial resolution. Furthermore, the monoscopic imaging mode allows to acquire images having a high time resolution. On the other hand, a stereoscopic imaging mode may provide the observer with a spatial impression of the object.

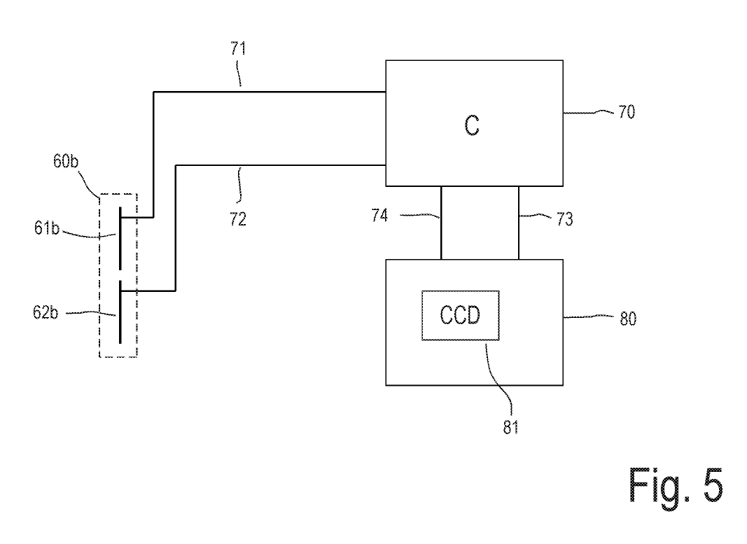

FIG. 5 shows a controller 70 of the microscope system 1, which is connected in signal communication with the image capture system 80. The image capture system 80 comprises an image sensor 81. The image capture system 80 may for example comprise a 1CCD-image sensor, a 1CMOS image sensor and/or a 3CCD image sensor. The image sensor 81 may have a size of ¼″, ⅓″, ½″, ¾″ or 1″.

The controller 70 is connected with a first area element 61b via a first signal line 71. Furthermore, the controller is connected with a second area element 62b via a second signal line 72. The controller 70 is configured to transmit control signals via the first signal line 71 to switch the first area element 61b between an open and a closed state. Accordingly, the controller 70 is configured to transmit control signals to the second area element 62b via the second signal line 72 to switch the second area element 62b between an open and a closed state.

Furthermore, the controller is connected with the image capture system 80 via a third and a fourth signal line 73, 74. The controller 70 is configured to transmit control signals to the image capture system 80 to capture a first image. The first image is acquired when the first area element 61a is switched to an open state and the second area element 62a is switched to a closed state. For example, controller 70 controls the opening time, in which the image sensor 81 records light intensity for the first individual image.

Accordingly, the controller 70 is configured to transmit control signal via signal line 74 for controlling the opening time, within which the image sensor 81 detects light intensity for the second image. The second individual image is acquired when the first area element 61a is switched to a closed state and the second area element 62a is switched to an open state. For example, the controller 70 is configured to transmit via the fourth signal line 74 the signal to control the opening time, within which the image sensor 81 detects light intensity for the second image.

The time window for the acquiring of the first individual image (i.e. the time period during which the image sensor detects light) may be longer, equal to or shorter than the opening time of the first area element 61a (i.e. the time period during which the first area element 61a is switched to an open state). Accordingly, a time window for the acquiring of the second individual image may be longer, equal to or shorter than the opening time of the second area element (i.e. the time period during which the second area element 62a is switched to an open state).

While the invention has been described with respect to certain exemplary embodiments thereof, it is evident that many alternatives, modifications and variations will be apparent to those skilled in the art. Accordingly, the exemplary embodiments of the invention set forth herein are intended to be illustrative and not limiting in any way. Various changes may be made without departing from the spirit and scope of the present invention as defined in the following claims.

What is claimed is:

1. A microscope system for acquiring a plurality of images, the microscope system comprising:
a zoom system configured to continuously vary a magnification of the microscope system over a magnification range of the microscope system, wherein the zoom system comprises two movable zoom components, which are arranged movably along a common optical axis of the microscope system;
an aperture stop configured such that a plurality of different observation beam paths of the microscope system are selectable, which traverse the zoom system;
wherein the aperture stop, as seen along the optical axis, is arranged between the two movable zoom components; and
wherein for all values of the magnification within the magnification range, the aperture stop is located within an aperture stop range which is measured along the optical axis and which surrounds a pupil position of the microscope system.

2. The microscope system according to claim 1 wherein the microscope system is configured such that a pupil range measured along the optical axis, has a length, which is smaller than a maximum distance of positions of lens vertices of the two movable zoom components.

3. The microscope system according to claim 1 further comprising:
an object side focusing system, which comprises a movable focusing component, wherein the microscope system is configured such that by moving the movable focusing component along the optical axis, a working distance of the microscope system is adjustable.

4. The microscope system according to claim 1 wherein at least one of the two movable zoom components or each of the two movable zoom components has a negative refracting power.

5. The microscope system according to claim 1 wherein the two movable zoom components are symmetrical or substantially symmetrical to each other.

6. The microscope system according to claim 1 wherein the zoom system further comprises a first group of two stationary zoom components, which are arranged on the optical axis between the two movable zoom components.

7. The microscope system according to claim 1 wherein the zoom system further comprises a second group of two stationary zoom components arranged on the optical axis, wherein the movable zoom components are arranged between the two stationary zoom components of the second group.

8. The microscope system according to claim 7 wherein one or each of the stationary zoom components of the second group has a positive refracting power.

9. The microscope system according to claim 7 wherein the stationary zoom components of the second group are symmetrical or substantially symmetrical to each other.

10. The microscope system according to claim 1 wherein the aperture stop is configured such that the observation beam paths are selectable by a variable aperture of the aperture stop.

11. The microscope system according to claim 1 wherein the aperture stop comprises one or more area elements, wherein each of the one or more area elements is configured to be switchable between an open and a closed state.

12. The microscope system according to claim 1 wherein the aperture stop is configured such that an aperture of the aperture stop is rotatable about the optical axis.

13. The microscope system according to claim 1 wherein the aperture stop comprises one or a combination of a mechanical shutter element, a polymer shutter element, or an LCD-matrix.

14. The microscope system according to claim 1 wherein the plurality of different observation beam paths comprise a left and right stereo channel.

15. The microscope system according to claim 1 wherein each of the plurality of observation beam paths has an f-number, which is less than 16.

16. The microscope system according to claim 1 wherein an overall length of the microscope system is less than 200 mm.

17. The microscope system according to claim 1 wherein a zoom ratio of the microscope system is at least 4×.

18. The microscope system according to claim 1 wherein the microscope system further comprises an image side focusing system, wherein a focal length of the image side focusing system is larger than a distance along the optical axis between a refractive surface of the image side focusing system, which is located closest to the zoom system, and the image plane.

19. The microscope system according to claim 1 wherein the zoom system is at least one of afocal system, a substantially afocal system, a symmetrical system, or a substantially symmetrical.

20. The microscope system according to claim 1 wherein the aperture stop is switchable between an open and a closed state.

21. The microscope system according to claim 20 wherein an opening time of the aperture stop is less than 500 ms.
